(19) United States
(12) Patent Application Publication
(10) Pub. No.: US 2026/0251463 A1
(43) Pub. Date: Aug. 27, 2026

(54) SYSTEMS AND METHODS FOR INCENTIVE-BASED VEHICLE ROUTING

(71) Applicants: TOYOTA MOTOR ENGINEERING & MANUFACTURING NORTH AMERICA, INC., PLANO, TX (US); MCMASTER UNIVERSITY, HAMILTON (CA)

(72) Inventors: YASHAR ZEIYNALI FARID, Mountain View, CA (US); HAO YANG, Hamilton (CA); SEYHAN UCAR, Mountain View, CA (US); KENTARO OGUCHI, Mountain View, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP); MCMASTER UNIVERSITY, HAMILTON, ON (CA)

(21) Appl. No.: 19/064,546

(22) Filed: Feb. 26, 2025

(51) Int. Cl. G01C 21/34; G08G 1/01

(52) U.S. Cl. CPC G01C 21/3415; G01C 21/3461; G01C 21/3469; G01C 21/3484; G01C 21/3492; G08G 1/012

(57) ABSTRACT

Aspects of the presently disclosed technology may be implemented to provide systems and methods for incentive-based vehicle routing. For example, a method may include determining a suggested route for a vehicle based on a location of a congested area of a road network to decrease congestion of the road network. The method may include determining an individualized incentive for an occupant of the vehicle to incentivize the occupant to follow the suggested route. The method may include transmitting, to the vehicle or to a device of the occupant, a message indicating the suggested route and the individualized incentive for following the suggested route, with the message providing an option for the occupant to accept the suggested route. The method may include, upon the occupant accepting the suggested route, updating an original route of the vehicle to the suggested route thereby directing the vehicle along the suggested route.

### TECHNICAL FIELD

The present disclosure relates generally to automotive systems and technologies. More particularly, some aspects relate to incentive-based vehicle routing.

### DESCRIPTION OF RELATED ART

Vehicle routing systems, such as GPS navigation systems, may generate a route for a vehicle through a road network and between a current location of the vehicle and a destination location of the vehicle. Generally, a vehicle routing system will generate a route that results in the least amount of travel time given a current traffic condition of the road network.

Accordingly, numerous drivers rely on vehicle routing systems even when the drivers are familiar with a particular area due to the vehicle routing systems'ability to account for changing traffic conditions.

### BRIEF SUMMARY OF THE DISCLOSURE

In accordance with an aspect of the disclosure, a method may include determining a suggested route for a vehicle based on a location of a congested area of a road network to decrease congestion of the road network. The method may include determining an individualized incentive for an occupant of the vehicle to incentivize the occupant to follow the suggested route. The individualized incentive may be determined based on a projected gain or loss of the occupant for following the suggested route. The method may include transmitting, to the vehicle or to a device of the occupant, a message indicating the suggested route and the individualized incentive for following the suggested route. The message may provide an option for the occupant to accept the suggested route. The method may include, upon the occupant accepting the suggested route, updating an original route of the vehicle to the suggested route thereby directing the vehicle along the suggested route.

In accordance with various aspects, the location of the congested area may be determined based on vehicle sensor data received from one or more other vehicles traversing the road network.

In accordance with various aspects, the method may include determining the occupant's projected gain for following the suggested route relative to the original route, wherein the occupant's projected gain for following the suggested route includes at least one of: (i) decreased travel time; (ii) decreased travel distance; (iii) decreased fuel or energy consumption; (iv) meeting one or more driver preferences; or (v) a decreased toll fee.

In accordance with various aspects, the method may include determining the occupant's projected loss for following the suggested route relative to the original route, wherein the occupant's projected loss for following the suggested route includes at least one of: (i) increased travel time; (ii) increased travel distance; (iii) increased fuel or energy consumption; (iv) failure to meet one or more driver preferences; or (v) an increased toll fee.

In accordance with various aspects, the individualized incentive may be determined further based on a potential of the vehicle for decreasing congestion of the road network; and the individualized incentive may increase as the potential of the vehicle for decreasing congestion of the road network increases.

In accordance with various aspects, the method may include determining the potential of the vehicle for decreasing congestion of the road network based on a comparison of the original route of the vehicle with the location of the congested area.

In accordance with various aspects, the individualized incentive may increase as a severity of the congested area increases.

In accordance with various aspects, the vehicle may comprise one of a plurality of connected vehicles that communicate with a server to wirelessly receive respective suggested routes; the individualized incentive may be determined further based on a ratio of the plurality of connected vehicles to non-connected vehicles that are traversing the road network; and the individualized incentive may increase as the ratio of the plurality of connected vehicles to the non-connected vehicles decreases.

In accordance with various aspects, the individualized incentive may be determined further based on a projected quantity of the plurality of connected vehicles that are required to accept the respective suggested routes to decrease congestion of the road network; and the individualized incentive may increase as the projected quantity of the plurality of connected vehicles that are required to accept the respective suggested routes to decrease congestion of the road network increases.

In accordance with various aspects, the method may include, prior to transmitting the message indicating the suggested route and the individualized incentive for following the suggested route, selecting the vehicle from the plurality of connected vehicles based on at least one of: (i) the ratio of the plurality of connected vehicles to the non-connected vehicles; (ii) a projected quantity of the plurality of connected vehicles that are required to accept the respective suggested routes to decrease congestion of the road network; (iii) respective compliance rates of the plurality of connected vehicles with accepting prior suggested routes; (iv) a potential of the vehicle for decreasing congestion of the road network; or (v) the occupant's projected gain or loss for following the suggested route.

In accordance with various aspects, the individualized incentive may comprise at least one of: (i) a monetary reward; (ii) an indication of a potential impact of the occupant on reducing traffic pollution by following the suggested route; or (iii) an indication of a potential energy or fuel savings of the occupant by following the suggested route.

In accordance with various aspects, the original route of the vehicle may prioritize a travel time of the vehicle; and the suggested route may prioritize decreasing congestion of the road network.

In accordance with an aspect of the disclosure, a system may include one or more processors; and memory storing machine-readable instructions that, when executed by the one or more processors, cause the system to: (i) determine a suggested route for a vehicle based on a location of a congested area of a road network to decrease congestion of the road network; (ii) determine an individualized incentive for an occupant of the vehicle to incentivize the occupant to follow the suggested route, the individualized incentive being determined based on a projected gain or loss of the occupant for following the suggested route; (iii) transmit, to the vehicle or to a device of the occupant, a message indicating the suggested route and the individualized incentive for following the suggested route, the message providing an option for the occupant to accept the suggested route; and (iv) responsive to the occupant accepting the suggested route, update an original route of the vehicle to the suggested route.

In accordance with various aspects, the memory may store further machine-readable instructions that, when executed by the one or more processors, cause the system to: determine the occupant's projected gain or loss for following the suggested route relative to the original route, wherein the occupant's projected gain or loss for following the suggested route includes at least one of: (i) decreased travel time; (ii) decreased travel distance; (iii) decreased fuel or energy consumption; (iv) meeting one or more driver preferences; (v) a decreased toll fee; (vi) increased travel time; (vii) increased travel distance; (viii) increased fuel or energy consumption; (ix) failure to meet one or more driver preferences; or (x) an increased toll fee.

In accordance with various aspects, the vehicle may comprise one of a plurality of connected vehicles that communicate with the system to wirelessly receive respective suggested routes; and the individualized incentive may be determined further based on at least one of: (i) a ratio of the plurality of connected vehicles to non-connected vehicles that are traversing the road network, wherein the individualized incentive increases as the ratio of the plurality of connected vehicles to the non-connected vehicles decreases; (ii) a potential of the vehicle for decreasing congestion of the road network, wherein the individualized incentive increases as the potential of the vehicle for decreasing congestion of the road network increases; or (iii) a projected quantity of the plurality of connected vehicles that are required to accept the respective suggested routes to decrease congestion of the road network, wherein the individualized incentive increases as the projected quantity of the plurality of connected vehicles that are required to accept the respective suggested routes to decrease congestion of the road network increases.

In accordance with various aspects, the vehicle may comprise one of a plurality of connected vehicles that communicate with the system to wirelessly receive respective suggested routes; and the memory may store further machine-readable instructions that, when executed by the one or more processors, cause the system to: prior to transmitting the message indicating the suggested route and the individualized incentive for following the suggested route, select the vehicle from the plurality of connected vehicles based on at least one of: (i) a ratio of the plurality of connected vehicles to non-connected vehicles; (ii) a projected quantity of the plurality of connected vehicles that are required to accept the respective suggested routes to decrease congestion of the road network; (iii) respective compliance rates of the plurality of connected vehicles with accepting prior suggested routes; (iv) a potential of the vehicle for decreasing congestion of the road network; or (v) the occupant's projected gain or loss for following the suggested route.

In accordance with various aspects, the individualized incentive may comprise at least one of: (i) a monetary reward; (ii) an indication of a potential impact of the occupant on reducing traffic pollution by following the suggested route; or (iii) an indication of a potential energy or fuel savings of the occupant by following the suggested route.

In accordance with an aspect of the disclosure, a system may include one or more processors; and memory storing machine-readable instructions that, when executed by the one or more processors, cause the system to: (i) determine a suggested route for a vehicle based on a location of a congested area of a road network to decrease congestion of the road network; (ii) determine an individualized incentive for an occupant of the vehicle to incentivize the occupant to follow the suggested route, the individualized incentive being determined based on one or more of: (a) a projected gain or loss of the occupant for following the suggested route, (b) a potential of the vehicle for decreasing congestion of the road network, or (c) a projected quantity of vehicles that are required to accept respective suggested routes to decrease congestion of the road network; (iii) transmit, to the vehicle or to a device of the occupant, a message indicating the suggested route and the individualized incentive for following the suggested route, the message providing an option for the occupant to accept the suggested route; and (iv) responsive to the occupant accepting the suggested route, instruct the vehicle to follow the suggested route.

In accordance with various aspects, the vehicles may comprise connected vehicles and the vehicle may comprise one of the connected vehicles, the connected vehicles being in communication with the system to wirelessly receive the respective suggested routes; and the memory may store further machine-readable instructions that, when executed by the one or more processors, cause the system to at least one of: (i) determine the occupant's projected gain or loss for following the suggested route relative to the original route; (ii) determine the potential of the vehicle for decreasing congestion of the road network based on comparing the original route of the vehicle with the location of the congested area; or (iii) determine the projected quantity of the vehicles that are required to accept the respective suggested routes to decrease congestion of the road network based on a ratio of the connected vehicles to non-connected vehicles that are traversing the road network.

In accordance with various aspects, the individualized incentive may comprise at least one of: (i) a monetary reward; (ii) an indication of a potential impact of the occupant on reducing traffic pollution by following the suggested route; or (iii) an indication of a potential energy or fuel savings of the occupant by following the suggested route.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example vehicle with which aspects of the systems and methods disclosed herein may be implemented.

FIG. 2 illustrates an example implementation of a vehicle routing system, in accordance with an aspect of the present disclosure.

FIG. 3A illustrates an example implementation of a vehicle routing system, in accordance with an aspect of the present disclosure.

FIG. 3B illustrates an example road network, in accordance with an aspect of the present disclosure.

FIGS. 4A-4C illustrate an example architecture for incentive-based vehicle routing, in accordance with an aspect of the present disclosure.

FIGS. 4D and 4E illustrate an example road network having congested areas, in accordance with an aspect of the present disclosure.

FIG. 5 illustrates an example process for incentive-based vehicle routing, in accordance with an aspect of the present disclosure.

FIG. 6 is an example computing component that may be used to implement various features of aspects described in the present disclosure.

The figures are not exhaustive and do not limit the present disclosure to the precise form disclosed.

### DETAILED DESCRIPTION

As described above, vehicle routing systems, such as GPS navigation systems, may generate a route for a vehicle through a road network and between a current location of the vehicle and a destination location of the vehicle. Generally, the vehicle routing systems will generate a route that results in the least amount of travel time given a current traffic condition of the road network. Although this decentralized or distributed routing approach may benefit certain individual drivers, attempting to generate a route that results in the least amount of travel time for each individual driver may result in the formation of congested areas or may fail to mitigate congested areas once they have formed.

A centralized approach to vehicle routing may be implemented to address these issues of a decentralized or distributed routing approach. For example, a centralized approach may generate routes that attempt to mitigate a congested area instead of routes that only prioritize individual drivers'travel time. However, conventional centralized approaches generally only attempt to mitigate particular congested streets of a road network and thus fail to mitigate the congestion of the road network as a whole or to improve the performance (e.g., average vehicle speeds, vehicle density, flow rates, etc.) of the road network.

Moreover, routes generated by centralized vehicle routing systems (e.g., that attempt to mitigate congestion) may have longer travel times compared to routes generated by decentralized or distributed vehicle routing systems (e.g., that prioritize the fastest travel time for an individual driver). Accordingly, many drivers may refuse to follow the routes generated by a centralized vehicle routing system and may instead follow routes generated by decentralized or distributed vehicle routing systems to shorten their own travel time. Thus, the centralized routing systems may fail to mitigate congestion because of drivers refusing to follow suggested routes.

Against this backdrop, the presently disclosed technology provides improved vehicle routing systems and methods that utilize individualized incentives for drivers that follow suggested routes. For example, aspects of the presently disclosed vehicle routing systems and methods may determine a respective location of one or more congested area(s) of a road network. The road network may be a collection of roads within a geographical area, such as within a city's limits. The respective location of the congested area(s) may be determined based on vehicle sensor data (e.g., vehicle speed data, vehicle location data, etc.) corresponding to vehicles traversing the road network, for example. The vehicle routing systems and methods may determine a suggested route for a vehicle based on the determined location of the congested area(s) to decrease congestion of the road network. For example, the suggested route may direct the vehicle to underutilized areas of the road network.

In addition, the vehicle routing systems and methods may determine an individualized incentive for a driver (or occupant) of the vehicle to incentivize following the suggested route. For example, the individualized incentive may be determined based on various factors (as described in more detail below) that may be unique to a particular driver thereby resulting in an incentive that is individualized instead of a generic incentive that is uniform for numerous drivers. These individualized incentives result in more drivers complying with suggested routes compared to no incentives or uniform incentives, and thus result in improved congestion mitigation. Moreover, the individualized incentive may account for the impact of taking the suggested route on the driver. For example, the individualized incentive may be increased if taking the suggested route results in an increased travel time or travel distance for the driver. In addition, the individualized incentive may account for the potential impact of the driver for mitigating congestion of the road network. For example, the individualized incentive may be increased if the driver would have a significant impact on mitigating congestion of the road network by following the suggested route.

In addition, the vehicle routing systems and methods may transmit, to the vehicle or to a mobile device of the driver (or occupant), a message indicating the suggested route and the individualized incentive for following the suggested route. The message, for example, may have an option for the driver (or occupant) to accept the suggested route (e.g., via a displayed graphical user interface). Upon the driver (or occupant) accepting the suggested route, the vehicle routing systems and methods may update an original route of the vehicle to the suggested route thereby directing the vehicle along the suggested route.

In addition, the presently disclosed vehicle routing systems and methods may select the driver from among other drivers for the offering of the suggested route and the individualized incentive based on various factors (as described in more detail below). The selection of the driver may improve the efficiency of the vehicle routing systems and methods by ensuring that only drivers who have a potential for mitigating congestion are offered an incentive, for example.

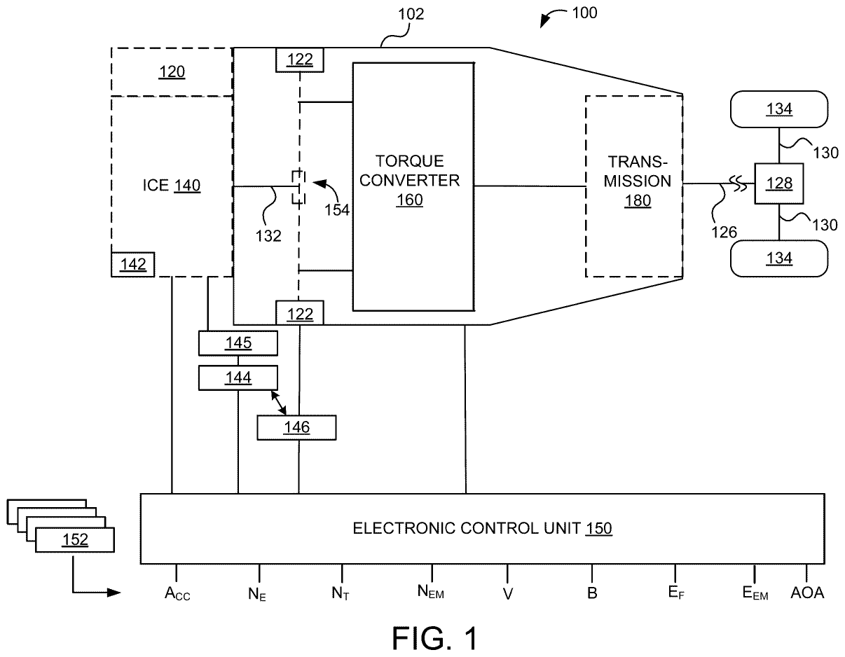

The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. An example hybrid electric vehicle (HEV) in which aspects of the disclosed technology may be implemented is illustrated in FIG. 1. Although the example described with reference to FIG. 1 is a hybrid type of vehicle, the systems and methods for incentive-based vehicle routing can be implemented in other types of vehicle including gasoline-or diesel-powered vehicles, alternate fuel-powered vehicles, fuel-cell vehicles, battery electric vehicles (BEVs), or other vehicles.

FIG. 1 illustrates a drive system 102 of a vehicle 100 that may include an internal combustion engine (ICE) 140 and one or more electric motor(s) 122 (which may also serve as generators, e.g., via regenerative braking or by being driven by the ICE 140) as sources of motive power. Driving force generated by the ICE 140 and electric motor(s) 122 may be transmitted to one or more wheels 134 via a torque converter 160, a transmission 180, a driveshaft 126, a differential gear device 128, and a pair of axles 130. In examples, the vehicle 100 may not include one or more of the ICE 140 (e.g., such as in BEV applications), the torque converter 160 (e.g., such as in dual clutch applications), the transmission 180 (e.g., such as in direct drive applications), or the differential gear device 128.

As an HEV, the vehicle 100 may be driven/powered with either or both of the ICE 140 and the electric motor(s) 122 as the drive source for travel. For example, a first travel mode may be an engine-only travel mode that only uses the ICE 140 as the source of motive power. A second travel mode may be an EV travel mode that only uses the electric motor(s) 122 as the source of motive power. A third travel mode may be an HEV travel mode that uses the ICE 140 and the electric motor(s) 122 as the sources of motive power or that uses the electric motor(s) 122 as the source of motive power while the ICE 140 is used to generate electrical energy for powering the electric motor(s) 122 or for charging a battery 144 of the vehicle 100. In the engine-only and HEV travel modes, the vehicle 100 may rely on a clutch 154 that may be included to engage the ICE 140 (e.g., by coupling a crankshaft (or output shaft) 132 of the ICE 140 to other components of the drive system). In the EV travel mode, the vehicle 100 may be powered by the motive force generated by the electric motor(s) 122 while the ICE 140 may be stopped and the clutch 154 disengaged.

The ICE 140 may combust a fuel (e.g., gasoline, diesel, ethanol, or other fuels) and oxygen mixture where, for example, the fuel is injected into and combusted in combustion chamber(s). A cooling system 120 may be provided to cool the ICE 140 by removing excess heat from ICE 140. For example, the cooling system 120 may be implemented to include a radiator, a water pump and a series of cooling channels. In operation, the water pump circulates coolant through the ICE 140 to absorb excess heat from the ICE 140. The heated coolant is circulated through the radiator to remove heat from the coolant, and the cold coolant can then be recirculated through the ICE 140. A fan may also be included to increase the cooling capacity of the radiator. The cooling system 120 (e.g., the water pump, the fan, etc.) may operate via a direct or indirect coupling to an output of the ICE 140. In other applications, the cooling system 120 (e.g., either or both the water pump and the fan) may be operated by the electric motor(s) 122 or by electrical energy such as from the battery 144.

In examples, the drive system 102 may include an output control circuit 142 may be provided to control force (e.g., output torque) of the ICE 140. The output control circuit 142 may include a throttle actuator to control an electronic throttle valve that controls fuel injection, an ignition device that controls ignition timing, and the like. The output control circuit 142 may execute output control of the ICE 140 according to a command control signal(s) supplied from an electronic control unit (ECU) 150, further described below. Such output control may include, for example, throttle control, fuel injection control, and ignition timing control.

The electric motor(s) 122 may be used to provide motive power for the vehicle 100 alone or in combination with the ICE 140. The electric motor(s) 122 may be powered electrically via the battery 144. The electric motor(s) 122 may be powered by the battery 144 to generate a motive force to move the vehicle and adjust vehicle speed. The electric motor(s) 122 may also function as a generator to generate electrical power such as, for example, when coasting or braking. The electric motor(s) 122 may be connected to the battery 144 via an inverter 146.

The battery 144 may be implemented as one or more batteries or other power storage devices including, for example, lead-acid batteries, nickel-metal hydride batteries, lithium ion batteries, capacitive storage devices, and so on. The battery 144 may be charged by a battery charger 145 that receives energy from the ICE 140. For example, an alternator or generator may be coupled directly or indirectly to an output shaft (e.g., the crankshaft 132) of the ICE 140 to generate an electrical current as a result of the operation of the ICE 140. In examples, a clutch may be included to engage/disengage the battery charger 145 from the ICE 140. The battery 144 may also be charged by the electric motor(s) 122 such as, for example, by regenerative braking or by coasting during which time the electric motor(s) 122 operate as generator(s). The battery 144 may also be used to power other electrical or electronic systems of the vehicle 100. In examples, the battery 144 may be charged via an external source such as in BEV applications or plug-in hybrid electric vehicle (PHEV) applications, for example.

The vehicle 100 may further include the ECU 150. The ECU 150 may control the drive system 102 of the vehicle 100 as well as other vehicle components and systems. For example, the ECU 150 may control the inverter 146, adjust the current supplied to the electric motor(s) 122, and adjust the current received from the electric motor(s) 122 during regenerative coasting and braking. As a more particular example, output torque of the electric motor(s) 122 may be increased or decreased by the ECU 150 through the inverter 146.

The ECU 150 may include circuitry to control various aspects of the vehicle 100's operation. The ECU 150 may include, for example, a microcomputer that includes one or more processing units (e.g., microprocessors), memory storage (e.g., RAM, ROM, etc.), and I/O devices. The processing units of the ECU 150 may execute instructions stored in memory to control one or more electrical systems or subsystems of the vehicle 100. The ECU 150 may include a plurality of ECUs such as, for example, an electronic engine control module, a powertrain control module, a transmission control module, a suspension control module, a body control module, and so on. As a further example, ECUs may be included to control systems and functions such as doors and door locking, lighting, human-machine interfaces, cruise control, telematics, braking systems (e.g., ABS or ESC), battery management systems, and so on. These various ECUs may be implemented using two or more separate ECUs, or using a single ECU.

In the example illustrated in FIG. 1, the ECU 150 may receive information (e.g., data) from sensors 152 included in the vehicle 100. For example, the ECU 150 may receive signals that indicate vehicle operating conditions or characteristics, or signals that can be used to derive vehicle operating conditions or characteristics. The vehicle operating conditions or characteristics may include (but are not limited to): an accelerator operation amount, AOA; a revolution speed, N_{E}, of the ICE 140 (engine RPM); a rotational speed, N_{EM}, of the electric motor(s) 122 (electric motor rotational speed); and a vehicle speed, V. The vehicle operating conditions or characteristics may also include: torque converter 160 output, N_{T} (e.g., output amps indicative of motor output); brake operation amount/pressure, B; and battery SOC (i.e., the charged amount of the battery 144 detected by an SOC sensor). Accordingly, the vehicle 100 may include sensors 152 that can be used to detect various conditions internal or external to the vehicle 100 and may provide sensed conditions to the ECU 150 (which, again, may be implemented as one or a plurality of individual control circuits). In examples, the sensors 152 may detect one or more condition(s) directly or indirectly such as, for example: fuel efficiency, E_{F}; electric motor(s) 122 efficiency, E_{EM}; hybrid (ICE 140+electric motor(s) 112) efficiency; acceleration, ACC, etc.

In examples, one or more of the sensors 152 may include their own processing capability to compute the results for additional information that can be provided to the ECU 150. In examples, in addition or alternatively, one or more of the sensors 152 may be data-gathering sensors that provide raw data to the ECU 150. In examples, in addition or alternatively, hybrid sensors may be included that provide a combination of raw data and processed data to the ECU 150. The sensors 152 may provide an analog output or a digital output, or a combination thereof.

The sensors 152 may be included to detect not only vehicle conditions but also to detect external conditions as well. For example, the sensors 152 may include one or more of camera sensors, sonar (e.g., ultrasonic) sensors, radar sensors, LiDAR sensors, infrared (IR) sensors, or other vehicle proximity or image sensors. The image sensors may be used to detect, for example, traffic signs indicating a current speed limit, road curvature, obstacles, and so on. In examples, the sensors 152 may include sensors that can detect road grade, road curvature, or other road conditions. While some of the sensors 152 may be used to actively detect passive environmental objects, other of the sensors 152 may be included and used to detect active objects (e.g., objects that are used to implement smart roadways and that may actively transmit and/or receive data or other information).

The example of FIG. 1 is provided for illustration purposes only as one example of vehicle systems with which aspects of the disclosed technology may be implemented. One of ordinary skill in the art reading this description will understand how the disclosed aspects can be implemented with this and other vehicle platforms (e.g., BEVs, fuel-cell vehicles, ICE vehicles, etc.).

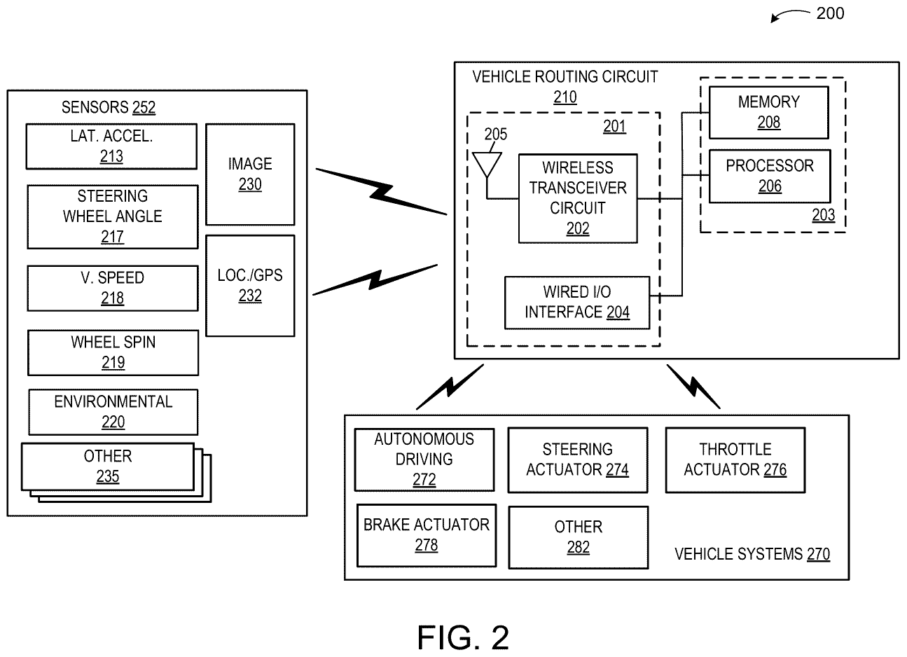

FIG. 2 illustrates an example architecture for incentive-based vehicle routing in accordance with an aspect of the systems and methods described herein. Referring now to FIG. 2, with continuing reference to FIG. 1, in this example, a vehicle routing system 200 (also may be referred to as an incentive-based vehicle routing system 200) includes a vehicle routing circuit 210, sensors 252, and additional vehicle systems 270. The sensors 252 and the additional vehicle systems 270 may communicate with the vehicle routing circuit 210 via a wired or wireless communication interface. Although the sensors 252 and the additional vehicle systems 270 are depicted as communicating with the vehicle routing circuit 210, they may also communicate with each other as well as with other vehicle systems. The vehicle routing circuit 210 may be implemented as an ECU or as part of an ECU such as, for example, the ECU 150 of FIG. 1. In examples, the vehicle routing circuit 210 may be implemented independently of the ECU 150.

The vehicle routing circuit 210 in this example includes a communication circuit 201 and a decision circuit 203 (including a processor 206 and memory 208 in this example). Components of the vehicle routing circuit 210 are illustrated as communicating with each other via a data bus, although other communication in interfaces can be included. The processor 206 may include one or more GPUs, CPUs, microprocessors, or any other suitable processing system. The processor 206 may include a single core or multicore processor(s). The memory 208 may include one or more various forms of memory or data storage (e.g., flash, RAM, etc.) that may be used to store the calibration parameters, images (analysis or historic), point parameters, instructions and variables for the processor 206 as well as any other suitable information. The memory 208 may be made up of one or more modules of one or more different types of memory and may be configured to store data and other information as well as operational instructions that may be used by the processor 206.

Although the example of FIG. 2 is illustrated using processor and memory circuitry, in examples the decision circuit 203 may be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up the vehicle routing circuit 210.

The communication circuit 201 may utilize either or both of a wireless transceiver circuit 202 with an associated antenna 205 and a wired I/O interface 204 with an associated hardwired data port. As illustrated by FIG. 2, communications with the vehicle routing circuit 210 may include either or both of wired and wireless communications. The wireless transceiver circuit 202 can include a transmitter and a receiver to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. The antenna 205 may be coupled to the wireless transceiver circuit 202 and may be used by the wireless transceiver circuit 202 to transmit signals (e.g., radio frequency signals) wirelessly to wireless equipment with which it is in communication with and to receive signals as well. These RF signals may include information of almost any sort that is sent or received by the vehicle routing circuit 210 to/from other entities such as the sensors 252, the additional vehicle systems 270, other vehicles, connected roadside infrastructure, cloud computing entities, remote servers, etc.

The wired I/O interface 204 may include a transmitter and a receiver for hardwired communications with other devices. For example, the wired I/O interface 204 may provide a hardwired interface to other components, including either or both the sensors 252 and the additional vehicle systems 270. The wired I/O interface 204 may communicate with other devices using Ethernet or any of a number of other wired communication protocols whether standardized, proprietary, open, point-to-point, networked or otherwise.

The sensors 252 may include additional sensors that may or may not otherwise be included on a vehicle with which the vehicle routing system 200 is implemented. The sensors 252 may include, for example, the sensors 152 described above with reference to the example of FIG. 1. In addition or alternatively, in examples, the sensors 252 may include lateral acceleration sensors 213 (e.g., one or more accelerometers, such as 3-axis accelerometers, that measure lateral acceleration and related data for vehicle 100, such as roll, pitch, yaw, and rates of change thereof), steering wheel angle/position sensors 217 (e.g., one or more sensors to detect an angle/position of a steering wheel of vehicle 100), and vehicle speed sensors 218 (e.g., one or more sensors to detect vehicle speed data indicating a speed of the vehicle 100). The sensors 252 may also include wheelspin sensors 219 (e.g., one for each wheel), environmental sensors 220 (e.g., to detect salinity, moisture, temperature, or other environmental conditions), image sensor(s) 230, and location sensor(s) 232. Other sensors 235 may also be included as may be appropriate for a given implementation of the vehicle 100 and vehicle routing circuit 210 or vehicle routing system 200. For example, the other sensors 235 may include proximity sensors such as radar sensors, LiDAR sensors, sonar sensors, etc.

In some embodiments, the image sensor(s) 230 may comprise one or more cameras (e.g., monocular cameras, stereoscopic cameras, RGB cameras, infrared (IR) cameras, etc.) configured to obtain image data of an environment surrounding the vehicle 100.

The location sensor(s) 232 may comprise a global navigation satellite sensor, a global position sensor (GPS), or other types of vehicle positioning sensors. The location sensor(s) 232 may be configured to generate location information or data for the vehicle 100 (e.g., vehicle location data) and/or location data for landmarks in the environment surrounding the vehicle 100 (e.g., intersections or corners of a road). The location data may comprise approximate coordinates (e.g., latitude, longitude, and altitude) of the vehicle 100's position on the Earth's surface. In examples, the location data may further comprise speed and/or direction information of the vehicle 100. As discussed herein, in certain implementations such location data can be used to determine the vehicle 100 is traversing a respective road or area of a road network.

In examples, one or more of the sensors 252 may include their own processing capability to compute the results for additional information that can be provided to the vehicle routing circuit 210. In addition or alternatively, in examples, one or more of the sensors 252 may be data-gathering sensors that provide raw data to the vehicle routing circuit 210. In addition or alternatively, in examples, one or more hybrid sensors may be included that provide a combination of raw data and processed data to the vehicle routing circuit 210. The sensors 252 may provide analog outputs, digital outputs, or a combination of both.

The additional vehicle systems 270 may include any of a number of different vehicle components or subsystems used to control or monitor various aspects of the vehicle 100 and its performance. For example, the additional vehicle systems 270 may include any one or combination of an autonomous driving system 272, a steering actuator 274, a throttle actuator 276, a brake actuator 278, or other vehicle systems 282. The other vehicle systems 282 may comprise various other types of vehicle systems utilized in the operation of the vehicle 100. For example, the other vehicle systems 282 may include one or more display systems (e.g., an infotainment unit that may display information and receive user input). In examples, the other vehicle systems 282 may include a human machine interface (HMI). For example, the HMI may include a display panel for displaying image information for a driver (or occupant), a speaker for outputting audio information, and actuation mechanisms, such as buttons or a touch panel used by the driver (or occupant) for performing an input operation. The HMI may also or alternatively transmit the information to the driver (or occupant) through a mobile information terminal connected wirelessly and receive the input operation by the driver (or occupant) through the mobile information terminal.

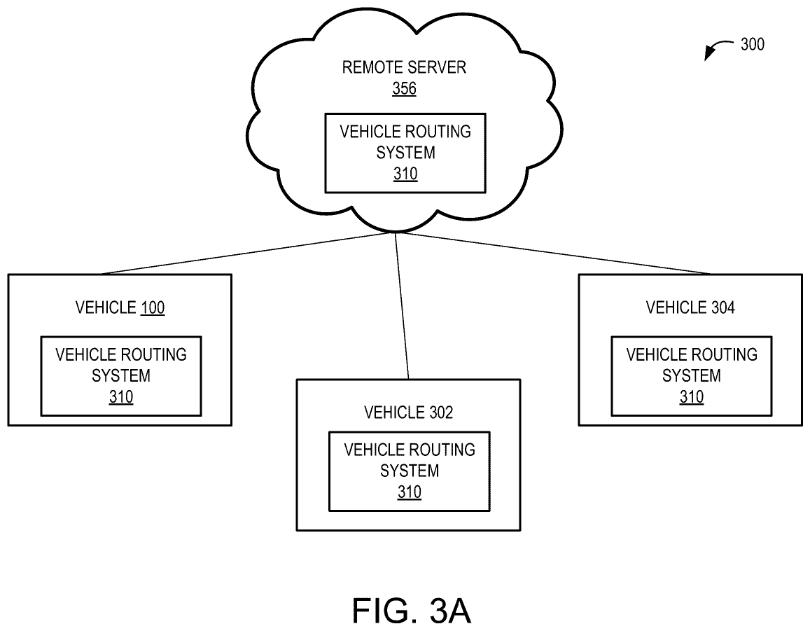

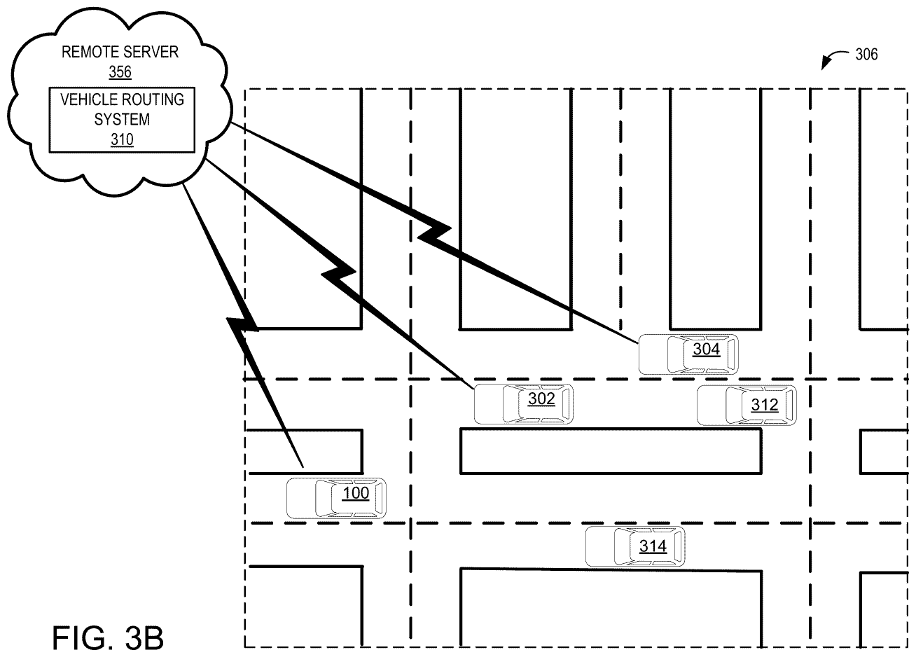

FIG. 3 depicts an example vehicle routing system 310, in accordance with various aspects of the presently disclosed technology. The vehicle routing system 310 may be an example of the vehicle routing system 200 from FIG. 2, for example.

As depicted in FIG. 3, in examples the vehicle routing system 310 may be implemented across a remote server 356 and one or more vehicles traversing a road network, such as vehicle 100, vehicle 302, and vehicle 304 (vehicles 302 and 304 may include the same or similar features as the vehicle 100 of FIG. 1). Such examples may be facilitated by a remote environment 300. The remove environment 300 may comprise a cloud-based environment, for example. In other examples, the remote environment 300 may comprise an edge-based environment. Such an edge-based environment can utilize various types of edge infrastructure, such as roadside/traffic infrastructure, cellular network infrastructure, etc. In some implementations, the remote environment 300 may be a combination of a cloud-based environment and an edge-based environment.

Accordingly, the vehicle routing system 310 may include separate instances within one or more entities of the remote environment 300, such as the remote server 356, vehicle 100, vehicle 302, and vehicle 304. In a further aspect, the entities that implement the vehicle routing system 310 within the remote environment 300 may vary beyond transportation-related devices and encompass roadside infrastructure elements. Thus, the set of entities that function in coordination with the remote environment 300 may be varied.

In some embodiments, the remote environment 300 itself may comprise a dynamic environment that comprises cloud members that migrate into and out of a geographic area.

FIG. 3B depicts the vehicles 100, 302, and 304 on an example road network 306. The vehicles 100, 302, and 304 may comprise connected vehicles, for example. That is, the vehicles 100, 302, and 304 have the ability to communicate with the remote server 356 of the vehicle routing system 310. Accordingly, the vehicle routing system 310 (e.g., via the remote server 356) may be in communication with the connected vehicles 100, 302, and 304 as the connected vehicles 100, 302, and 304 traverse the road network 306. As depicted in FIG. 3B, the road network 306 may also include non-connected vehicles, such as vehicles 312 and 314. The non-connected vehicles 312 and 314 may be conventional vehicles that are not in communication with the remote server 356 of the vehicle routing system 310.

The road network 306 may be a collection of roads (e.g., including streets, highways, etc.) within a geographic area. The bounds of the road network 306 may be fixed or dynamic. For example, the bounds of the road network 306 may be based on city limits, county limits, state boarders, etc. In examples, the bounds of the road network 306 may be defined as desired (e.g., based on square miles, current density/quantity of vehicles, density of roads, or the like).

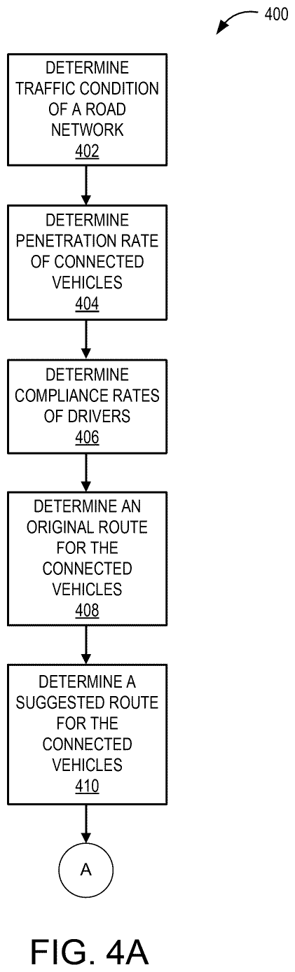

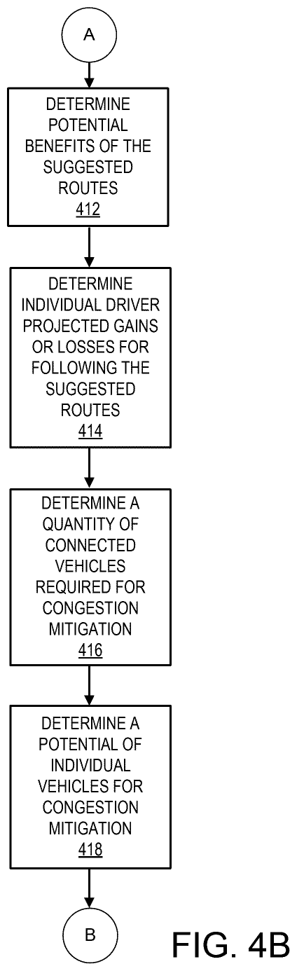

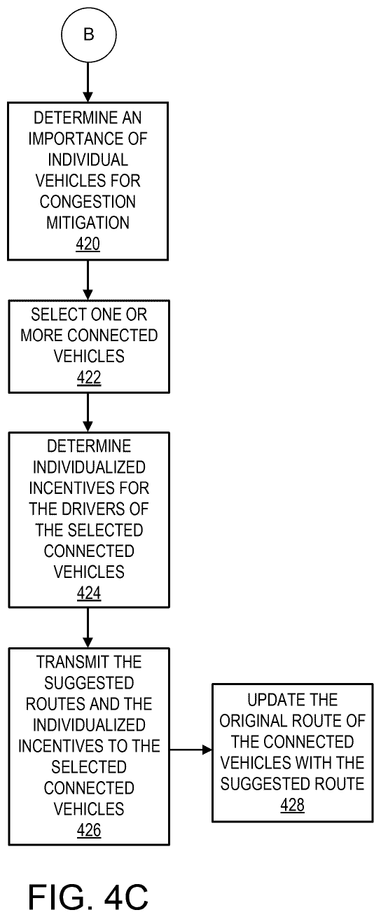

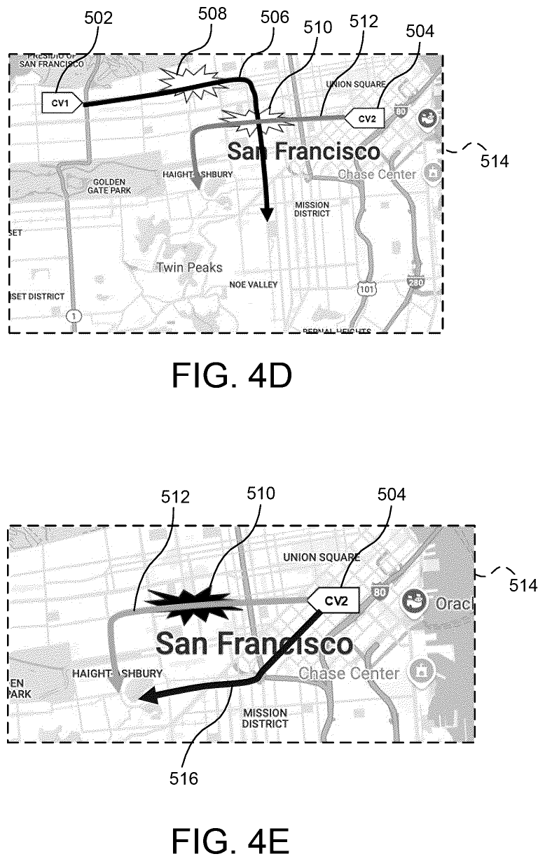

FIGS. 4A-4C illustrate an example vehicle routing system 400 architecture for incentive-based vehicle routing. The system 400 of FIGS. 4A-4C may be executed at a remote server (e.g., the remote server 356 of FIG. 3), one or more vehicles (e.g., vehicles 100, 302, and 304), or a combination thereof. The vehicle routing system 400 may be an example of the vehicle routing systems 200 and 310 from FIGS. 2, 3A, and 3B, for example. The vehicle routing system 400 may determine a traffic condition of a road network (e.g., the road network 306 of FIG. 3B) at block 402. Determining the traffic condition of the road network may comprise determining the locations of one or more congested area(s) of the road network. In examples, determining the traffic condition of the road network may further comprise determining the severity of the congested area(s) of the road network. For example, the vehicle routing system 400 may determine the locations or severity of the congested area(s) based on real-time vehicle sensor data that is received from one or more connected vehicles (e.g., vehicles 100, 302, and 304).

The vehicle sensor data may include, for example, vehicle speed data and vehicle location data (e.g., obtained via the vehicle speed sensor 218 and the location sensor(s) 232 of respective vehicles) corresponding to the connected vehicle(s) as the connected vehicle(s) traverse the road network. The vehicle routing system 400 may determine the locations and severity of the congested area(s) by determining/estimating one or more of traffic flows, traffic densities, or average vehicle speeds of respective roads of the road network based on the real-time vehicle sensor data. In examples, the vehicle routing system 400 may determine the locations and severity of the congested area(s) further based on historical vehicle sensor data or historical traffic data. For example, the vehicle routing system 400 may determine the locations and severity of the congested area(s) by comparing the real-time vehicle sensor data with the historical data. As an example scenario, the vehicle routing system 400 may infer that specific areas of the road network are congested based on either or both of lower than average vehicle speeds (e.g., based on historical average vehicle speeds or posted speed limits) and higher than average vehicle density (e.g., based on historical average vehicle density).

In addition or alternatively, in examples, determining the location of the congested area may comprise determining (or predicting) a location of a future congested area of the road network. For example, if a ball game is scheduled to start at 5:00 pm (e.g., at a location within the road network), the vehicle routing system 400 may predict traffic before it starts. The vehicle routing system 400 may receive event data or information that indicates the start times and locations of various events from, for example, one or more databases that are in communication with the vehicle routing system 400 (e.g., via the Internet). As another example, if historical traffic data indicates that a particular area becomes congested around a certain time or that a prior event has caused congestion, the vehicle routing system 400 may predict that a congested area may form in that particular area at the certain time or around the event when the event occurs again. Accordingly, the vehicle routing system 400 may determine or predict the location(s) of congested area(s) based on one or more of event data or information, historical traffic data, or a combination thereof.

At block 404, the vehicle routing system 400 may determine the penetration rate of connected vehicles based on the vehicle sensor data. For example, based on the determined traffic flows/densities of the respective roads of the road network, the vehicle routing system 400 may determine the ratio of connected vehicles to non-connected vehicles traversing the road network, or traversing specific roads or areas of the road network. As an example, if the vehicle routing system 400 determines that a particular area or road of the road network currently has ten (10) vehicles traversing that particular area or road, and only three (3) of those ten (10) vehicles are in communication with the vehicle routing system 400, then the vehicle routing system 400 may determine that the ratio of connected vehicles to non-connected vehicles for that particular area or road is three (3) to seven (7).

At block 406, the vehicle routing system 400 may determine or estimate a compliance rate of respective driver(s) (or occupant(s)) of the connected vehicle(s) for accepting suggested routes from the vehicle routing system 400. For example, the vehicle routing system 400 may determine the compliance rate of the respective driver(s) for accepting suggested routes based on one or more of the determined traffic condition of the road network, historical compliance rate data, or driver characteristic data. The historical compliance rate data may indicate, for example, the number of times a particular driver has accepted prior suggested routes from the vehicle routing system 400 and the number of times the particular driver has denied suggested routes from the vehicle routing system 400. Examples of driver characteristic data may include, but are not limited to, driver information (such as age, preferred route(s), etc.), driver type (conservative driving, impatient driving, etc.), vehicle info/type, and/or location information of the driver.

At block 408, the vehicle routing system 400 may determine an original (or first) route for the respective connected vehicle(s). The original route may be, for example, the shortest route (e.g., based on distance/time) between a starting or current location of the connected vehicle(s) and a destination of the connected vehicle(s) given the current traffic state of the road network. Thus, the original route is the likely route a driver would follow if the driver is primarily concerned about their personal travel time or travel distance.

At block 410, the vehicle routing system 400 may determine a suggested (or second) route for the respective connected vehicle(s) (e.g., between the starting or current location of the respective connected vehicle(s) and the destination of the respective connected vehicle(s)). For example, the vehicle routing system 400 may determine the suggested route based on the traffic condition (e.g., the locations and severity of the congested area(s)) of the road network. In examples, the vehicle routing system 400 may determine the suggested route based on one or more of a current traffic condition or a predicted/future traffic condition as described above. The suggested route may be, for example, a route that would help improve the traffic condition of the road network by directing a respective connected vehicle away from or around the congested area(s) or the predicted/future congested area(s) (e.g., through non-congested or underutilized roads or areas of the road network). Accordingly, the suggested route may result in a route that is longer (e.g., based on time and/or distance) than the original route. Thus, instead of prioritizing an individual vehicle's travel time or distance like the original route, the suggested route may prioritize the traffic condition of the road network.

The vehicle routing system 400 may comprise a centralized traffic routing system that determines suggested routes for respective connected vehicles to improve or optimize the traffic condition of the whole road network (or, in examples, areas of the road network). In examples, the vehicle routing system 400 may utilize macroscopic fundamental diagrams (MFDs) to determine the suggested routes. An MFD, for example, may be a diagram that shows density and flow rate relationships for a road network within a map (not just a single road segment). The MFD of a road network may be analyzed for macroscopic behaviors. When traffic density is near zero, traffic is at free flow (no congestion). As the traffic flow rate increases, the traffic density also increases until reaching a critical density point. At critical density, the road network has a maximum flow rate which is the full capacity of the road network. After critical density, congestion occurs (i.e., the flow rates decrease and traffic density increases). The decrease in flow and increase in density continues to occur until a jam density is reached in which there is a maximum traffic density and a flow rate of zero (e.g., gridlock).

In examples, the vehicle routing system 400 may dynamically partition a road network into a plurality of smaller partitions (e.g., regions) based on real-world traffic conditions, and generate MFDs for each of the regions based on link states within the area. The vehicle routing system 400 can identify smaller areas of homogenous traffic flow rates, congestion, and/or the like within the larger predetermined area such as a city, town, state, etc. Each of these similar pockets of traffic in the grid can be clustered together in a partition. The partitions may be calibrated using historical traffic data associated with the area to confirm or verify the traffic patterns are typical for that area. The vehicle routing system 400 may use the calibrated MFDs for each partition of the network and adjust routing algorithms to reduce demand in congested areas. For example, the vehicle routing system 400 may adjust link costs within the routing algorithms based on the analysis of the MFDs to affect vehicle routings. Furthermore, the vehicle routing system 400 can apply perimeter control by transmitting instructions to vehicles to reduce inflows to the congested regions and mitigate traffic congestion.

At block 412, the vehicle routing system 400 may determine the potential benefits of the suggested routes. For example, the vehicle routing system 400 may determine the potential benefits of the suggested routes relative to the original routes. That is, given the traffic situation of the road network, the penetration rate of the connected vehicle(s), and the compliance rate of the driver(s) of the connected vehicle(s), the vehicle routing system 400 determines whether the congested area(s) may be mitigated by the connected vehicle(s) following the suggested routes. As an example, if mitigating a particular congested area requires at least 30% of vehicles (e.g., that have an original route through the particular congested area) to follow a respective suggested route, but the penetration rate of the connected vehicles is 20%, the vehicle routing system 400 may determine that there are no (or not enough) potential benefits of the suggested routes. Accordingly, the vehicle routing system 400 may determine that the particular congested area cannot be mitigated at the present time and may attempt to mitigate a different congested area, or may periodically determine one or more of new suggested route(s), penetration rate(s), compliance rate(s), or potential benefits of the suggested route(s) until the vehicle routing system 400 determines that particular congested area(s) can be mitigated.

The vehicle routing system 400 may determine that particular congested area(s) can be mitigated by the connected vehicle(s) following the suggested route(s)—and thus determine that the suggested route(s) have potential benefits—when the suggested route(s) would result in, for example, one or more of increased traffic flow, increased average vehicle speeds, decreased density, or decreased travel time through the congested area(s).

At block 414, the vehicle routing system 400 may determine the projected gain(s) or loss(es) of individual driver(s) (or occupant(s)) for following the suggested route(s). For example, the vehicle routing system 400 may determine an individual driver's projected gain or loss for following a respective suggested route relative to the original route of the driver. The driver's projected gain for following the suggested route may include, but is not limited to, at least one of decreased travel time, decreased travel distance, decreased fuel or energy consumption, meeting one or more driver preferences, or a decreased toll fee. The driver's projected loss for following the suggested route may include, but are not limited to, at least one of increased travel time, increased travel distance, increased fuel or energy consumption, failure to meet one or more driver preferences, or an increased toll fee. As an example, the vehicle routing system 400 may determine that if a particular driver were to follow the suggested route instead of the original route, the particular driver may experience a gain of a 2% decrease in fuel or energy consumption, but losses of a five (5) minute longer travel time and a two (2) mile longer travel distance.

The driver preferences may correspond to preferences of the driver (or occupant) for routes. In examples, the vehicle routing system 400 may allow the driver (or occupant) to set the one or more driver preferences. The driver preferences may include, but are not limited to: freeways over back roads (e.g., to avoid car sickness); scenery preferences (e.g., rural vs city); road condition (e.g., newly paved/smooth roads over old/bumpy roads); avoiding construction zones; avoiding industrial areas (e.g., to avoid factories or areas having unpleasant odors); or the like. Accordingly, the vehicle routing system 400 may determine the projected gain of a driver as including one or more of the driver preferences when the suggested route meets one or more of the driver preferences, and may determine the projected loss of the driver as failing to include one or more of the driver preferences.

At block 416, the vehicle routing system 400 determines a quantity (or percentage) of connected vehicles required for mitigating the congestion of the road network. For example, the vehicle routing system 400 may determine the quantity of the connected vehicles required for mitigating the congestion of the congested area(s) based on the traffic condition of the road network and the determined potential benefits of the suggested routes. As an example, the vehicle routing system 400 may determine that for mitigating two (2) congested areas of the road network, at least 20% and 10% of connected vehicles (e.g., that have original routes through or proximate to the respective two (2) congested areas), respectively, need to follow the suggested routes to mitigate the congested areas and improve performance (e.g., based on average vehicle speeds, traffic flow, density distribution, etc.) of the road network.

At block 418, the vehicle routing system 400 may determine a potential of individual vehicles for mitigating the congestion of the congested areas and the overall road network. For example, the vehicle routing system 400 may determine the potential of an individual vehicle for decreasing congestion of the road network based on comparing the original route of the vehicle with the locations of the congested areas. The potential of an individual vehicle for decreasing congestion of the road network may increase as a quantity of the congested areas that are positioned along the original route of the individual vehicle increases. Accordingly, a first vehicle that is projected to drive through two (2) congested areas while traversing its original route may have a higher potential for decreasing congestion of the road network than a second vehicle that is projected to drive through one (1) congested area (or no congested areas) while traversing its original route, for example. In examples, the potential of the individual vehicle for decreasing congestion of the road network may increase as a severity of the congested areas that are positioned along the original route of the individual vehicle increases. Accordingly, a first vehicle that is projected to drive through a first heavily congested area while traversing its original route may have a higher potential for decreasing congestion of the road network than a second vehicle that is projected to drive through a second lightly congested area (e.g., relative to the first congested area) while traversing its original route, for example.

At block 420, the vehicle routing system 400 may determine an importance of individual vehicles for mitigating congestion of the congested area(s) and the overall road network. For example, the vehicle routing system 400 may determine the importance of an individual vehicle for mitigating congestion of the congested area(s) and the overall road network based on: (i) the potential of the individual vehicle for mitigating the congestion of the congested areas and the overall road network; the quantity (or percentage) of connected vehicles required for mitigating the congestion of the road network; and (iii) the penetration rate of the connected vehicle(s). The importance of an individual vehicle for mitigating congestion of the congested area(s) and the overall road network may increase as one or more of: (i) the potential of the individual vehicle for mitigating the congestion of the congested areas and the overall road network increases; (ii) the quantity (or percentage) of connected vehicles required for mitigating the congestion of the road network increases; or (iii) the penetration rate of the connected vehicle(s) decreases. As an example, if the current penetration rate of connected vehicles is 30% and the required penetration rate to mitigate a congested area is 30%, then all the connected vehicles have a high importance. Moreover, if a particular connected vehicle can participate in mitigating multiple congested areas and/or severe congested areas (i.e., the original route of the particular connected vehicle is through the multiple/severe congested areas), the particular connected vehicle will have a higher importance relative to other connected vehicles that can not participate in mitigating multiple congested areas and/or severe congested areas.

At block 422, the vehicle routing system 400 may select one or more of the connected vehicle(s) for sending the suggested route(s). The vehicle routing system 400 may select one or more of the connected vehicle(s) based on one or more of: (i) the importance of the individual connected vehicles for mitigating congestion of the congested area(s) and the overall road network; (ii) respective drivers'projected gains or losses for following a respective suggested route; (iii) the quantity of the connected vehicles required for mitigating the congestion of the congested area(s) and/or the overall road network, or (iv) the compliance rate of the respective drivers. As an example, if all connected vehicles are determined to have the same or similar importance, at least twenty (20) of the connected vehicles are required to follow the suggested routes, and the predicted compliance rate is 50%, then the vehicle routing system 400 may sort the available connected vehicles based on their respective gains and losses and select forty (40) connected vehicles that have the highest gains/lowest losses.

At block 424, the vehicle routing system 400 may determine individualized incentives for respective drivers of the selected connected vehicles. The individualized incentives may incentivize the respective drivers to accept and follow the suggested routes. For example, the vehicle routing system 400 may determine the individualized incentives based on one or more of: (i) the projected gain or loss of the respective drivers (or occupants) for accepting and following the suggested routes; (ii) the potential of the respective connected vehicles for decreasing congestion of the congestion area(s) and the road network; (iii) the penetration rate of the connected vehicles (i.e., the ratio/percentage of the connected vehicles to non-connected vehicles that are traversing the road network); or (iv) the projected quantity of connected vehicles that are required to accept the respective suggested routes to decrease congestion of the road network. A respective individualized incentive may increase as one or more of: (i) the projected loss of a respective driver (or occupant) increases; (ii) the potential of a respective connected vehicle for decreasing congestion of the road network increases; (iii) the ratio of connected vehicles to the non-connected vehicles (i.e., the penetration rate) decreases; or (iv) the projected quantity of connected vehicles that are required to accept respective suggested routes to decrease congestion of the road network increases.

The individualized incentive may include, but is not limited to, one or more of: (i) a monetary reward; (ii) an indication of the respective driver's (or occupant's) potential impact on reducing traffic pollution by following the suggested route; or (iii) an indication of the respective driver's (or occupant's) potential energy or fuel savings by following the suggested route. For example, the monetary reward may include, but is not limited to: credits or tokens from sponsors; money payments; nonfungible tokens (NFTs); gaming like rewards or tokens (e.g., that can be redeemed for prizes); or the like. Accordingly, in examples, the individualized incentive may comprise a monetary reward with a magnitude that is determined based on the above discussed factors.

In examples, the individualized incentive may be determined further based on driver characteristics. For example, if a particular driver's characteristics indicates the driver cares about their potential impact on reducing overall traffic pollution, the individualized incentive may include an indication of the driver's potential impact on reducing traffic pollution by following the suggested route.

At block 426, the vehicle routing system 400 may transmit the suggested route(s) and the individualized incentive(s) to the selected connected vehicle(s) or to respective device(s) (e.g., a mobile device, a phone, a tablet, a laptop, or other computing device) of the driver(s) (or occupant(s)). For example, the vehicle routing system 400 may transmit a message to respective connected vehicles indicating the suggested route and the individualized incentive for following the suggested route, with the message having an option for the driver (or occupant) to accept the suggested route. In examples where the individualized incentive is monetary, the vehicle routing system 400 may deposit the monetary incentive into an account (e.g., a checking account, a rewards account, etc.) of the driver (or occupant) upon the driver (or occupant) accepting the suggested route or upon the driver (or occupant) completing the suggested route.

At block 428, upon the driver (or occupant) accepting the suggested route, the vehicle routing system 400 may update the original route of the driver's vehicle with the suggested route. In examples where a connected vehicle is an autonomous vehicle, upon the driver (or occupant) accepting the suggested route, the vehicle routing system 400 may control or cause the autonomous vehicle to follow the suggested route.

FIGS. 4D and 4E illustrate an example scenario where the vehicle routing system 400 may determine the locations of congested areas of a road network 514. As illustrated in FIG. 4D, the vehicle routing system 400 may determine a location of a first congested area 508 and a second congested area 510 of the road network 514. Moreover, the vehicle routing system 400 may determine (or generate) a first original route 506 for a first connected vehicle 502 (labeled as CV1 in FIG. 4D) and a second original route 512 for a second connected vehicle 504 (labeled as CV2 in FIG. 4D). As illustrated in FIG. 4D, the vehicle routing system 400 may determine that the first original route 506 passes through the first congested area 508 and the second congested area, and that the second original route 510 passes through the second congested area 510. As described above, the vehicle routing system 400 may determine suggested routes and individualized incentives for the first connected vehicle 502 and the second connected vehicle 504 based on the locations/severity of the congested areas 508 and 510. For example, as illustrated in FIG. 4E, the vehicle routing system 400 may determine (or generate) a suggested route 516 for the second connected vehicle 504 that may be longer (e.g., based on time/distance) than the second original route 512, but that mitigates the congestion of the second congested area 510 and the road network 514.

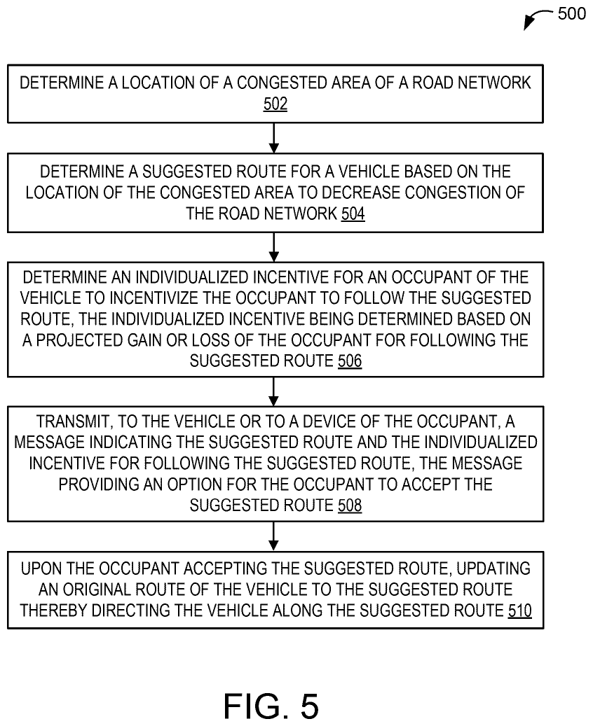

FIG. 5 illustrates an example process 500 that may be performed by any of the vehicle routing systems 200, 310, 400 of FIGS. 2-4E to mitigate congestion of a road network, in accordance with various aspects of the presently disclosed technology. The exemplary process 500, however, is not limited to the exemplary vehicle routing systems 200, 310, 400 of FIGS. 2-4E.

The process 500 may include determining a location of a congested area (or locations of congested areas) of a road network (502). As described above, in examples the location of the congested area may be determined based on vehicle sensor data. The vehicle sensor data may be received from (and correspond to) one or more other vehicles traversing the road network. As described above, the vehicle sensor data may include, but is not limited to, vehicle speed data and vehicle location data. As described above, the determined location of the congested area may correspond to a current or real-time congested area. As described above, in addition or alternatively, determining the location of the congested area may comprise determining (or predicting) a location of a future/predicted congested area of the road network.

The process 500 may include determining a suggested route for a vehicle based on the determined location of the congested area (or future/predicted congested area) to decrease congestion of the road network (504).

The process 500 may include determining an individualized incentive for an occupant (or driver) of the vehicle to incentivize the occupant to follow the suggested route, the individualized incentive being determined based on a projected gain or loss of the occupant for following the suggested route (506). As described above, in examples the individualized incentive may be determined further based on a potential of the vehicle for decreasing congestion of the road network. The individualized incentive may increase as the potential of the vehicle for decreasing congestion of the road network increases, for example. In examples, the process 500 may further include determining the potential of the vehicle for decreasing congestion of the road network based on a comparison of the original route of the vehicle with the location of the congested area. As described above, the potential of the vehicle for decreasing congestion of the road network may increase when the original route of the vehicle passes through the congested area (or may increase as a quantity of congested areas that are located along the original route increases). As described above, the potential of the vehicle for decreasing congestion of the road network may increase as a severity of the congested area that the original route passes through increases. As described above, the individualized incentive may include, but is not limited to, at least one of: (i) a monetary reward; (ii) an indication of a potential impact of the occupant on reducing traffic pollution by following the suggested route; or (iii) an indication of a potential energy or fuel savings of the occupant by following the suggested route.

The process 500 may include transmitting, to the vehicle or to a device of the occupant, a message indicating the suggested route and the individualized incentive for following the suggested route, the message providing an option for the occupant to accept the suggested route (508).

The process 500 may include, upon the occupant accepting the suggested route, updating an original route of the vehicle to the suggested route thereby directing the vehicle along the suggested route (510). As described above, the original route of the vehicle may prioritize a travel time of the vehicle, and the suggested route may prioritize decreasing congestion of the road network.

In examples, the process 500 may further include determining the occupant's projected gain for following the suggested route relative to the original route. As described above, the occupant's projected gain for following the suggested route may include, but is not limited to, at least one of: (i) decreased travel time; (ii) decreased travel distance; (iii) decreased fuel or energy consumption; (iv) meeting one or more driver preferences; or (v) a decreased toll fee.

In examples, the process 500 may further include determining the occupant's projected loss for following the suggested route relative to the original route. As described above, the occupant's projected loss for following the suggested route may include, but is not limited to, at least one of: (i) increased travel time; (ii) increased travel distance; (iii) increased fuel or energy consumption; (iv) failure to meet one or more driver preferences; or (v) an increased toll fee.

In examples, the vehicle may comprise one of a plurality of connected vehicles that communicate with a server (e.g., the remote server 356) to wirelessly receive respective suggested routes. As described above, in examples the individualized incentive may be determined further based on a ratio of the plurality of connected vehicles to non-connected vehicles that are traversing the road network. The individualized incentive may increase as the ratio of the plurality of connected vehicles to the non-connected vehicles decreases, for example. In examples, the individualized incentive may be determined further based on a projected quantity of the plurality of connected vehicles that are required to accept the respective suggested routes to decrease congestion of the road network. The individualized incentive may increase as the projected quantity of the plurality of connected vehicles that are required to accept the respective suggested routes to decrease congestion of the road network increases, for example. In examples, the process 500 may further comprise, prior to transmitting the message indicating the suggested route and the individualized incentive for following the suggested route, selecting the vehicle from the plurality of connected vehicles based on at least one of: (i) the ratio of the plurality of connected vehicles to the non-connected vehicles; (ii) a projected quantity of the plurality of connected vehicles that are required to accept the respective suggested routes to decrease congestion of the road network; (iii) respective compliance rates of the plurality of connected vehicles with accepting prior suggested routes; (iv) a potential of the vehicle for decreasing congestion of the road network; or (v) the occupant's projected gain or loss for following the suggested route.

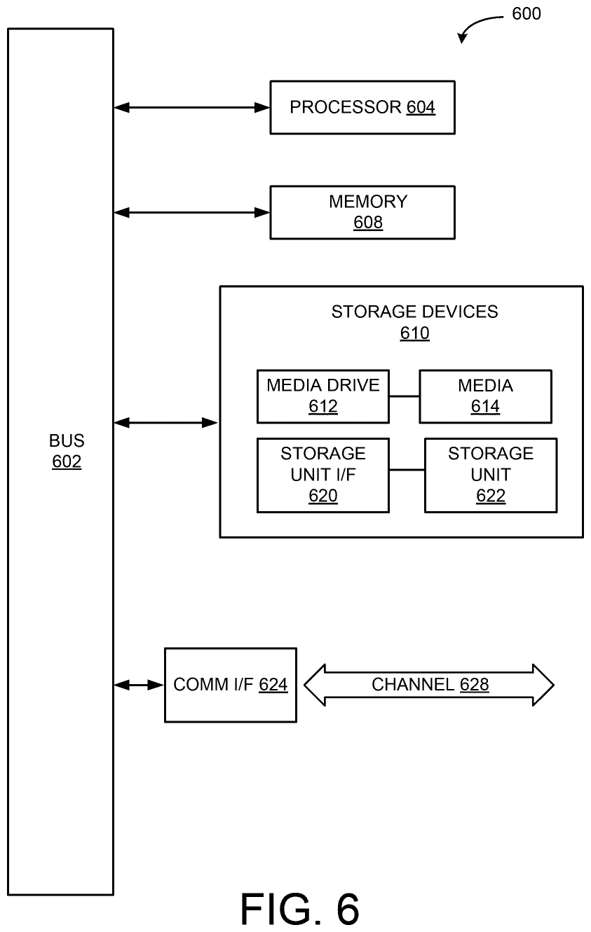

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionalities can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 6. Various embodiments are described in terms of this example-computing component 600. After reading this description, it will become apparent to a person skilled in the relevant art how to implement the application using other computing components or architectures.

Referring now to FIG. 6, computing component 600 may represent, for example, computing or processing capabilities found within a self-adjusting display, desktop, laptop, notebook, and tablet computers. They may be found in hand-held (or mobile) computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 600 might also represent computing capabilities embedded within or otherwise available to a given device. For example, a computing component might be found in other electronic devices such as, for example, portable computing devices, and other electronic devices that might include some form of processing capability.

Computing component 600 might include, for example, one or more processors, controllers, control components, or other processing devices. Processor 604 might be implemented using a general-purpose or special-purpose processing engine such as, for example, a microprocessor, controller, or other control logic. Processor 604 may be connected to a bus 602. However, any communication medium can be used to facilitate interaction with other components of computing component 600 or to communicate externally.

Computing component 600 might also include one or more memory components, simply referred to herein as main memory 608. For example, random access memory (RAM) or other dynamic memory, might be used for storing information and instructions to be executed by processor 604. Main memory 608 might also be used for storing temporary variables or other intermediate information during execution of instructions to be executed by processor 604. Computing component 600 might likewise include a read only memory (“ROM”) or other static storage device coupled to bus 602 for storing static information and instructions for processor 604.

The computing component 600 might also include one or more various forms of information storage mechanism 610, which might include, for example, a media drive 612 and a storage unit interface 620. The media drive 612 might include a drive or other mechanism to support fixed or removable storage media 614. For example, a hard disk drive, a solid-state drive, a magnetic tape drive, an optical drive, a compact disc (CD) or digital video disc (DVD) drive (R or RW), or other removable or fixed media drive might be provided. Storage media 614 might include, for example, a hard disk, an integrated circuit assembly, magnetic tape, cartridge, optical disk, a CD or DVD. Storage media 614 may be any other fixed or removable medium that is read by, written to or accessed by media drive 612. As these examples illustrate, the storage media 614 can include a computer usable storage medium having stored therein computer software or data.

In alternative embodiments, information storage mechanism 610 might include other similar instrumentalities for allowing computer programs or other instructions or data to be loaded into computing component 600. Such instrumentalities might include, for example, a fixed or removable storage unit 622 and an interface 620. Examples of such storage units 622 and interfaces 620 can include a program cartridge and cartridge interface, a removable memory (for example, a flash memory or other removable memory component) and memory slot. Other examples may include a PCMCIA slot and card, and other fixed or removable storage units 622 and interfaces 620 that allow software and data to be transferred from storage unit 622 to computing component 600.

Computing component 600 might also include a communications interface 624. Communications interface 624 might be used to allow software and data to be transferred between computing component 600 and external devices. Examples of communications interface 624 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 624 may be carried on signals, which can be electronic, electromagnetic (which includes optical) or other signals capable of being exchanged by a given communications interface 624. These signals might be provided to communications interface 624 via a channel 628. Channel 628 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 608, storage unit 622, media 614, and channel 628. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 600 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
determining a suggested route for a vehicle based on a location of a congested area of a road network to decrease congestion of the road network;
determining an individualized incentive for an occupant of the vehicle to incentivize the occupant to follow the suggested route, the individualized incentive being determined based on a projected gain or loss of the occupant for following the suggested route;
transmitting, to the vehicle or to a device of the occupant, a message indicating the suggested route and the individualized incentive for following the suggested route, the message providing an option for the occupant to accept the suggested route; and
upon the occupant accepting the suggested route, updating an original route of the vehicle to the suggested route thereby directing the vehicle along the suggested route.

2. The method of claim 1, wherein the location of the congested area is determined based on vehicle sensor data received from one or more other vehicles traversing the road network.

3. The method of claim 1, further comprising determining the occupant's projected gain for following the suggested route relative to the original route,
wherein the occupant's projected gain for following the suggested route includes at least one of:
decreased travel time;
decreased travel distance;
decreased fuel or energy consumption;
meeting one or more driver preferences; or
a decreased toll fee.

4. The method of claim 1, further comprising determining the occupant's projected loss for following the suggested route relative to the original route,
wherein the occupant's projected loss for following the suggested route includes at least one of:
increased travel time;
increased travel distance;
increased fuel or energy consumption;
failure to meet one or more driver preferences; or
an increased toll fee.

5. The method of claim 1, wherein:
the individualized incentive is determined further based on a potential of the vehicle for decreasing congestion of the road network; and
the individualized incentive increases as the potential of the vehicle for decreasing congestion of the road network increases.

6. The method of claim 5, further comprising determining the potential of the vehicle for decreasing congestion of the road network based on a comparison of the original route of the vehicle with the location of the congested area.

7. The method of claim 5, wherein the individualized incentive increases as a severity of the congested area increases.

8. The method of claim 1, wherein:
the vehicle comprises one of a plurality of connected vehicles that communicate with a server to wirelessly receive respective suggested routes;
the individualized incentive is determined further based on a ratio of the plurality of connected vehicles to non-connected vehicles that are traversing the road network; and
the individualized incentive increases as the ratio of the plurality of connected vehicles to the non-connected vehicles decreases.

9. The method of claim 8, wherein:
the individualized incentive is determined further based on a projected quantity of the plurality of connected vehicles that are required to accept the respective suggested routes to decrease congestion of the road network; and
the individualized incentive increases as the projected quantity of the plurality of connected vehicles that are required to accept the respective suggested routes to decrease congestion of the road network increases.

10. The method of claim 8, further comprising:
prior to transmitting the message indicating the suggested route and the individualized incentive for following the suggested route, selecting the vehicle from the plurality of connected vehicles based on at least one of:
the ratio of the plurality of connected vehicles to the non-connected vehicles;
a projected quantity of the plurality of connected vehicles that are required to accept the respective suggested routes to decrease congestion of the road network;
respective compliance rates of the plurality of connected vehicles with accepting prior suggested routes;
a potential of the vehicle for decreasing congestion of the road network; or
the occupant's projected gain or loss for following the suggested route.

11. The method of claim 1, wherein the individualized incentive comprises at least one of:
a monetary reward;
an indication of a potential impact of the occupant on reducing traffic pollution by following the suggested route; or
an indication of a potential energy or fuel savings of the occupant by following the suggested route.

12. The method of claim 1, wherein:
the original route of the vehicle prioritizes a travel time of the vehicle; and
the suggested route prioritizes decreasing congestion of the road network.

13. A system comprising:
one or more processors; and
memory storing machine-readable instructions that, when executed by the one or more processors, cause the system to:
determine a suggested route for a vehicle based on a location of a congested area of a road network to decrease congestion of the road network;
determine an individualized incentive for an occupant of the vehicle to incentivize the occupant to follow the suggested route, the individualized incentive being determined based on a projected gain or loss of the occupant for following the suggested route;
transmit, to the vehicle or to a device of the occupant, a message indicating the suggested route and the individualized incentive for following the suggested route, the message providing an option for the occupant to accept the suggested route; and
responsive to the occupant accepting the suggested route, update an original route of the vehicle to the suggested route.

14. The system of claim 13, wherein the memory stores further machine-readable instructions that, when executed by the one or more processors, cause the system to:
determine the occupant's projected gain or loss for following the suggested route relative to the original route,
wherein the occupant's projected gain or loss for following the suggested route includes at least one of:
decreased travel time;
decreased travel distance;
decreased fuel or energy consumption;
meeting one or more driver preferences;
a decreased toll fee;
increased travel time;
increased travel distance;
increased fuel or energy consumption;
failure to meet one or more driver preferences; or
an increased toll fee.

15. The system of claim 13, wherein:
the vehicle comprises one of a plurality of connected vehicles that communicate with the system to wirelessly receive respective suggested routes; and
the individualized incentive is determined further based on at least one of:
a ratio of the plurality of connected vehicles to non-connected vehicles that are traversing the road network, wherein the individualized incentive increases as the ratio of the plurality of connected vehicles to the non-connected vehicles decreases;
a potential of the vehicle for decreasing congestion of the road network, wherein the individualized incentive increases as the potential of the vehicle for decreasing congestion of the road network increases; or
a projected quantity of the plurality of connected vehicles that are required to accept the respective suggested routes to decrease congestion of the road network, wherein the individualized incentive increases as the projected quantity of the plurality of connected vehicles that are required to accept the respective suggested routes to decrease congestion of the road network increases.

16. The system of claim 13, wherein:
the vehicle comprises one of a plurality of connected vehicles that communicate with the system to wirelessly receive respective suggested routes; and
the memory stores further machine-readable instructions that, when executed by the one or more processors, cause the system to:
prior to transmitting the message indicating the suggested route and the individualized incentive for following the suggested route, select the vehicle from the plurality of connected vehicles based on at least one of:
a ratio of the plurality of connected vehicles to non-connected vehicles;
a projected quantity of the plurality of connected vehicles that are required to accept the respective suggested routes to decrease congestion of the road network;
respective compliance rates of the plurality of connected vehicles with accepting prior suggested routes;
a potential of the vehicle for decreasing congestion of the road network; or
the occupant's projected gain or loss for following the suggested route.

17. The system of claim 13, wherein the individualized incentive comprises at least one of:
a monetary reward;
an indication of a potential impact of the occupant on reducing traffic pollution by following the suggested route; or
an indication of a potential energy or fuel savings of the occupant by following the suggested route.

18. A system comprising:
one or more processors; and
memory storing machine-readable instructions that, when executed by the one or more processors, cause the system to:
determine a suggested route for a vehicle based on a location of a congested area of a road network to decrease congestion of the road network;
determine an individualized incentive for an occupant of the vehicle to incentivize the occupant to follow the suggested route, the individualized incentive being determined based on one or more of:
a projected gain or loss of the occupant for following the suggested route,
a potential of the vehicle for decreasing congestion of the road network, or
a projected quantity of vehicles that are required to accept respective suggested routes to decrease congestion of the road network;
transmit, to the vehicle or to a device of the occupant, a message indicating the suggested route and the individualized incentive for following the suggested route, the message providing an option for the occupant to accept the suggested route; and
responsive to the occupant accepting the suggested route, instruct the vehicle to follow the suggested route.

19. The system of claim 18, wherein:
the vehicles comprise connected vehicles and the vehicle comprises one of the connected vehicles, the connected vehicles being in communication with the system to wirelessly receive the respective suggested routes; and
the memory stores further machine-readable instructions that, when executed by the one or more processors, cause the system to at least one of:
determine the occupant's projected gain or loss for following the suggested route relative to the original route;
determine the potential of the vehicle for decreasing congestion of the road network based on comparing the original route of the vehicle with the location of the congested area; or
determine the projected quantity of the vehicles that are required to accept the respective suggested routes to decrease congestion of the road network based on a ratio of the connected vehicles to non-connected vehicles that are traversing the road network.

20. The system of claim 18, wherein the individualized incentive comprises at least one of:
a monetary reward;
an indication of a potential impact of the occupant on reducing traffic pollution by following the suggested route; or
an indication of a potential energy or fuel savings of the occupant by following the suggested route.
